(19) United States
(12) Patent Application Publication
(10) Pub. No.: US 2026/0270604 A1
(43) Pub. Date: Sep. 10, 2026

(54) CLIP-ON EARPHONE

(71) Applicant: Guangdong Genius Technology Co., Ltd., Dongguan, Guangdong (CN)

(72) Inventor: Guanjie Qian, Dongguan, Guangdong (CN)

(73) Assignee: Guangdong Genius Technology Co., Ltd., Dongguan, Guangdong (CN)

(21) Appl. No.: 19/489,337

(22) PCT Filed: May 9, 2024
(86) PCT No.: PCT/CN2024/091968

§ 371 Date: Dec. 2, 2025

(30) Foreign Application Priority Data
Jun. 29, 2023 (CN) 202310785824.3

(51) Int. Cl. H04R 1/10

(52) U.S. Cl. CPC H04R 1/105; H04R 1/1066

(57) ABSTRACT

The present invention relates to the field of earphones. Disclosed is an ear-clip earphone, comprising a functional portion (10), a clipping portion (20), and a rotating shaft mechanism (30). The functional portion (10) comprises a first shell (11); the clipping portion (20) comprises a second shell (21); and the first shell (11) is rotatably connected to the second shell (21) by means of the rotating shaft mechanism (30) to adjust and fix the included angle between the functional portion (10) and the clipping portion (20), thereby forming a clipping space for clipping an ear. According to the present invention, the earphone deforms by means of rotation of the rotating shaft mechanism (30) to clip the ear; the rotating shaft mechanism (30) can stop rotation at any angle and fix a clipping angle; and when the earphone is in the worn state, the rotating shaft mechanism (30) will not continuously apply pressure to an auricle, such that better wearing comfort is achieved, the wearing comfort problem of the earphone can be solved, and the present invention is adapted to different wearers.

### FIELD OF THE DISCLOSURE

The present application relates to a technical field of earphone technology, and particularly to a clip-on earphone.

### BACKGROUND

With the development of electronic devices, smartphones, tablets, and other electronic products have become widely used in our daily life. Wireless earphones, as an important accessory for these products, are also becoming increasingly common. Existing earphone types comprise in-ear, semi-in-ear, earbud, ear-hook, and clip-on earphones, each with its own advantages. Among these, clip-on earphones are mostly open-ear headphones (the earphone body does not extend into the ear canal). Open-ear headphones have advantages such as not hurting the ears, not damaging hearing, and being comfortable to wear.

There are many ways that clip-on earphones hold onto the ear. Currently, the most common clip-on earphones on the market mainly utilize material deformation to hold onto the ear and prevent it from falling out. However, using material deformation to hold onto the ear may cause ear pain due to the continuous clamping force applied to the ear, especially for people with thicker pinnae where the clamping force is greater and the ear pain is more pronounced.

### SUMMARY OF THE INVENTION

The purpose of this application is to provide a clip-on earphone that solves the problem of wearing comfort and is adaptable for different wearers.

The present application provides the following technical solution.

A clip-on earphone, comprising:
a functional part, comprising a first housing;
a clamping part, comprising a second housing;
a pivot mechanism; wherein the first housing and the second housing are rotatably connected via the pivot mechanism, for adjusting and holding an angle between the functional part and the clamping part to form a clamping space for engaging with an ear.

In some embodiments, the functional part further comprises a first bracket fixedly disposed in the first housing; and
the clamping part further comprises a second bracket fixedly disposed in the second housing; and
the second bracket is rotatably connected to the first bracket via the pivot mechanism.

In some embodiments, the pivot mechanism comprises a rotating shaft and a roll part;
wherein the rotating shaft passes through the first bracket and its two ends are rotatably connected to the second bracket, and the roll part is fixed in the first bracket and wound around the rotating shaft, and an inner surface of the roll part contacts an outer surface of the rotating shaft, and a friction force between the roll part and the rotating shaft generates rotational damping.

In some embodiments, the first bracket has a stepped hole, comprising a first through hole and a second through hole;
wherein a diameter of the first through hole is smaller than a diameter of the second through hole, and the roll part is disposed in the second through hole, and the rotating shaft passes through a center of the first through hole and the roll part.

In some embodiments, an inner surface of the first through hole is provided with a protrusion, and the outer surface of the rotating shaft is provided with a recessed portion;
wherein the recessed portion engages with the protrusion to limit a rotation angle of the rotating shaft relative to the first bracket.

In some embodiments, the first housing is provided with a first limiting part, and
the second housing is provided with a second limiting part;
wherein the first limiting part and the second limiting part cooperate to limit a rotation angle of the second housing relative to the first housing.

In some embodiments, the roll part comprises a fixing portion and a roll portion;
wherein a first end of the roll portion is connected to the fixing portion, and a second end of the roll portion is spaced apart from the first end of the roll portion to form an opening, and the fixing portion is fixed in the first bracket, and the roll portion is wound on the rotating shaft; and
when changing from a non-wearing state to a wearing state, an angle between the clamping part and the functional part decreases, and a span of the opening increases, and the friction force between the roll part and the rotating shaft decreases; and
when changing from the wearing state to the non-wearing state, the angle between the clamping part and the functional part increases, and the span of the opening decreases, and the friction force between the roll part and the rotating shaft increases.

In some embodiments, the fixing portion is disposed in the first bracket and facing
the first housing, and the opening is disposed below the fixing portion; or
the fixing portion is disposed in the first bracket and facing the second housing, and the opening is disposed above the fixing portion.

In some embodiments, the pivot mechanism comprises a rotating shaft, a cam, and a positioning pin;
wherein the second housing is rotatably connected to the first housing via the rotating shaft, and the cam is sleeved on the rotating shaft and fixedly connected to the first housing, and the cam is provided with multiple positioning teeth, wherein the positioning pin is fixedly disposed in the second housing; and when the positioning pin engages with any of the positioning teeth, a rotation angle between the second housing and the first housing is adjusted.

Some embodiments further comprising an elastic mechanism, movably mounted at the second housing;
wherein one end of the elastic mechanism abuts against the second housing, and one other end abuts against the positioning pin, so that the positioning pin is able to move along a length direction of the second housing.

In some embodiments, the elastic mechanism comprises a spring seat and a spring;
wherein the spring seat is movably disposed in the second housing, and the spring is sleeved on the spring seat with one end abutting against the second housing, and the positioning pin abuts against the spring seat.

In some embodiments, multiple positioning teeth are arranged sequentially along a thickness direction of the cam;
wherein heights of the multiple position teeth decrease sequentially along the thickness direction of the cam, and the positioning pin is movable along a width direction of the second housing, wherein moving the positioning pin along the width direction of the second housing allows the positioning pin to engage with different one of the positioning teeth to adjust the rotation angle between the second housing and the first housing.

In some embodiments, a side of the spring seat that abuts against the positioning pin is provided with a plurality of recessed grooves along the width direction of the second housing, and an end of positioning pin is provided with a mating portion adapted to engage with the recessed grooves; and
when the positioning pin moves along the width direction of the second housing, the mating portion is able to be in different recessed grooves, and the positioning pin is positioned by an engagement between the recessed grooves and the mating portion.

In some embodiments, the multiple positioning teeth are arranged sequentially along a circumferential direction of the cam.

In some embodiments, the pivot mechanism comprises a rotating shaft, a worm, a worm wheel, and a cam rod;
wherein the second housing is rotatably connected to the first housing via the rotating shaft, and the worm is rotatably disposed in the first housing, and the worm wheel is sleeved on the rotating shaft and is rotatable relative to the rotating shaft, and the worm wheel has a teeth portion and a groove on its outer circumference, and the teeth portion meshes with the worm, and the cam rod is fixedly disposed at the second housing and is adapted to engage with the groove.

Some embodiments further comprising an elastic mechanism, movably mounted at the second housing;
wherein one end of the elastic mechanism abuts against the second housing, and one other end is connected to the cam rod, so that the cam rod is able to move along a length direction of the second housing.

In some embodiments, the elastic mechanism comprises a spring seat and a spring;
wherein the spring seat is movably disposed in the second housing, and the spring is sleeved on the spring seat with one end abutting against the second housing, and the cam rod is fixedly connected to the spring seat.

In some embodiments, the outer circumference of the worm wheel is further provided with a limiting groove;
wherein the teeth portion, the groove, and the limiting groove are arranged sequentially at intervals in a clockwise direction at the outer circumference of the worm wheel; and in a wearing state, the cam rod is located in the groove; and
in a non-wearing state, the cam rod is located in the limiting groove, and a first side surface of the limiting groove is inclined relative to a horizontal plane and exerts a pre-pressure on the cam rod, so that when the worm rotates, the second housing is always in an aligned state.

In some embodiments, when the teeth portion of the worm wheel moves to a top of the worm, the cam rod is located at a top of the first side surface; and when the teeth portion of the worm wheel move to a bottom of the worm, the cam rod is located at a bottom of the first side surface.

The technical advantages of this application are: the pivot mechanism enables the earphone to change its shape and clamp an ear. The pivot mechanism can stop and hold the clamping angle at any angle. Upon wearing, the pivot mechanism does not continuously apply pressure to the pinna, resulting in better wearing comfort. This application can solve the problem of wearing comfort and is adaptable for different wearers.

### BRIEF DESCRIPTION OF THE DRAWINGS

This application will be further described in detail below with reference to the accompanying drawings and specific embodiments.

FIG. 1 is a schematic diagram of a clip-on earphone provided in an embodiment of this application in a non-wearing state.

FIG. 2 is a structural schematic diagram of the clip-on earphone provided in the embodiment of this application in a wearing state.

FIG. 3 is a cross-sectional view of the clip-on earphone provided in Embodiment 1 of this application in the non-wearing state.

FIG. 4 is a cross-sectional view of the clip-on earphone provided in Embodiment 1 of this application in the wearing state.

FIG. 5 is a schematic diagram of the internal structure of the clip-on earphone provided in Embodiment 1 of this application in the non-wearing state.

FIG. 6 is a schematic diagram of the structure of the first bracket of the clip-on earphone provided in Embodiment 1 of this application.

FIG. 7 is a schematic diagram of the pivot mechanism of the clip-on earphone provided in Embodiment 1 of this application.

FIG. 8 is a schematic diagram of the structure of the ear clip earphone's roll part provided in Embodiment 1 of this application.

FIG. 9 shows another way of configuring the roll part of the clip-on earphone provided in Embodiment 1 of this application.

FIG. 10 is a structural schematic diagram of a clip-on earphone provided in Embodiment 2 of this application in a non-wearing state.

FIG. 11 is a cross-sectional view of the clip-on earphone provided in Embodiment 2 of this application in a wearing state.

FIG. 12 is a schematic diagram of a positioning pin and an elastic mechanism of the clip-on earphone provided in Embodiment 2 of this application.

FIG. 13 is a cross-sectional view of a clip-on earphones provided in Embodiment 3 of this application in a non-wearing state.

FIG. 14 is a schematic diagram of a cam rod and a limiting groove of the clip-on earphone provided in Embodiment 3 of this application.

FIG. 15 is a cross-sectional view of the clip-on earphones provided in Embodiment 3 of this application in the wearing state.

FIG. 16 is a schematic diagram of the matching cam rod and limiting groove of the clip-on earphone provided in Embodiment 3 of this application.

FIG. 17 is a schematic diagram of the external structure of the clip-on earphone provided in Embodiment 3 of this application.

### EXPLANATION OF REFERENCE NUMBERS

10: Functional part; 11: First housing; 12: First bracket; 121: First through hole; 1211: Protrusion; 122: Second through hole; 13: Third bracket; 20: Clamping part; 21: Second housing; 211: Arc-shaped portion; 22: Second bracket; 30: Pivot mechanism; 31: Rotating shaft; 311: Recessed portion; 32: Roll part; 321: Fixing portion; 322: Roll portion; 3221: Opening; 33: Cam; 331: Positioning tooth; 34: Positioning pin; 341: Mating portion; 35: Worm; 36: Worm wheel; 361: Teeth portion; 362: Groove; 363: Limiting groove; 3631: First side surface; 37: Cam rod; 38: Hand-operated member; 40: Elastic mechanism; 41: Spring seat; 411: Recessed groove; 42: Spring.

### DESCRIPTION OF THE ILLUSTRATED EMBODIMENTS

To more clearly illustrate the technical solutions in the embodiments of the present application or the prior art, the drawings used in the description of the embodiments or the prior art will be briefly introduced below. Obviously, the drawings described below are only some embodiments of the present application. For those skilled in the art, other drawings can be obtained based on these drawings without creative effort.

To make the drawings concise, only relevant parts of this application are shown schematically in each figure, and they do not represent the actual structure of a product. Furthermore, for ease of understanding, in some figures, only one of components with the same structure or function is shown schematically, or only one is labeled. In this document, “one” can mean not only “only one” but also “more than one”.

It should also be further understood that the term “and/or” as used in this application specification and the appended claims means any combination of one or more of the associated listed items and all possible combinations, and comprises such combinations.

In this document, it should be noted that, unless otherwise explicitly specified and limited, the terms “installation,” “connection,” and “linkage” should be interpreted broadly. For example, they can refer to fixed connections, detachable connections, or integral connections. They can refer to mechanical connections or electrical connections. They can refer to direct connections or indirect connections through an intermediate medium. And they can refer to the internal communication between two components. Those skilled in the art can understand the specific meaning of the above terms in this application based on the specific circumstances.

Furthermore, in the description of this application, the terms “first,” “second,” etc., are used only to distinguish features and should not be construed as indicating or implying relative importance.

### Example 1

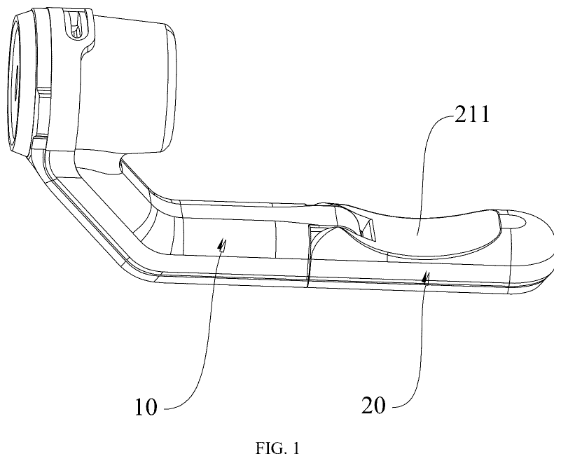

As shown in FIGS. 1 to 9, a clip-on earphone comprises a functional part 10, a clamping part 20, and a pivot mechanism 30. The functional part 10 comprises a first housing 11. The clamping part 20 comprises a second housing 21. The first housing 11 and the second housing 21 are rotatably connected by the pivot mechanism 30, which is used to adjust and hold an angle between the functional part 10 and the clamping part 20 to form a clamping space for engaging with an ear.

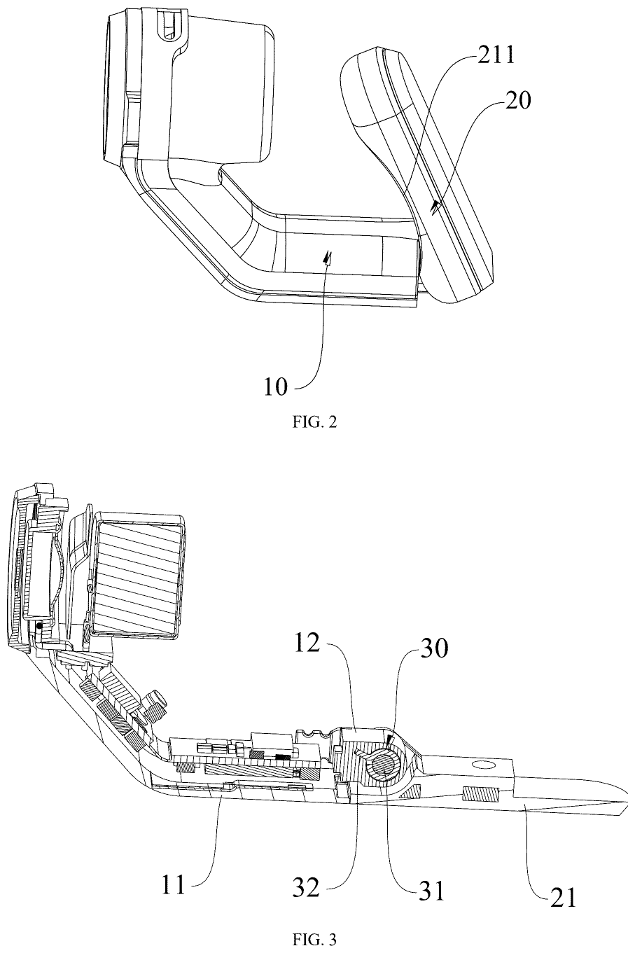

Specifically, the clip-on earphone of this embodiment is divided into two main parts: a functional part 10 and a clamping part 20, which are connected together by a pivot mechanism 30. The functional part 10 is used to realize the earphone function. Various electronic components for realizing the earphone function are provided inside the first housing 11. At the same time, the first housing 11 is also provided with a speaker hole and a microphone hole. The speaker hole is used for broadcasting, and the microphone hole is used for receiving sound. The clamping part 20 is mainly used to realize the clamping function when wearing the earphone. The clip-on earphone may have two states: a non-wearing state and a wearing state. In the non-wearing state, as shown in FIG. 1, the connection between the first housing 11 and the second housing 21 is on a same plane of the second housing 21, and the second housing 21 is in an aligned state. In the wearing state, as shown in FIG. 2, the second housing 21 rotates toward the first housing 11, and the second housing 21 is not in an aligned state. The connection between the first housing 11 and the second housing 21 is not on the same plane of the second housing 21, and a clamping space for engaging with the ear can be formed between the functional part 10 and the clamping part 20. Upon wearing, the functional part 10 is located in front of the ear and close to the ear canal, and the clamping part 20 is located behind the ear, forming a clamping space between the clamping part 20 and the functional part 10 to clamp the ear. Preferably, as shown in FIGS. 1 and 2, the inner side of the second housing 21 is provided with a recessed arc-shaped portion 211. In the wearing state, after the second housing 21 is folded toward the first housing 11, an arc-shaped clamping space with a larger inner space and a smaller outer opening can be formed between the arc-shaped portion 211 and the first housing 11 for clamping the pinna. This not only provides a more secure clamping but also better matches the shape of the ear, making it more comfortable to wear.

The second housing 21 of the clamping part 20 and the first housing 11 of the functional part 10 are rotatably connected by a pivot mechanism 30. The pivot mechanism 30 can change the angle between the second housing 21 and the first housing 11, that is, change the angle between the functional part 10 and the clamping part 20, so that the clip-on earphone can adapt to the ears of different wearers. In addition, the pivot mechanism 30 can also hold the rotation angle, so that the clamping part 20 does not continuously apply pressure to the ears during the wearing duration, and the wearing comfort is improved.

In this embodiment, as shown in FIG. 5, the functional part 10 further comprises a first bracket 12 fixedly disposed in the first housing 11. The clamping part 20 further comprises a second bracket 22 fixedly disposed in the second housing 21. The second bracket 22 and the first bracket 12 are rotatably connected via the pivot mechanism 30. The first bracket 12 is fixed in the first housing 11 by means of overmolding or the like, and the second bracket 22 is fixed in the second housing 21 by means of overmolding or the like. Of course, if the process allows, the first bracket 12 can also be integrally formed with the first housing 11, and the second bracket 22 can also be integrally formed with the second housing 21, that is, the first bracket 12 and the first housing 11 are one component, and the second bracket 22 and the second housing 21 are one component.

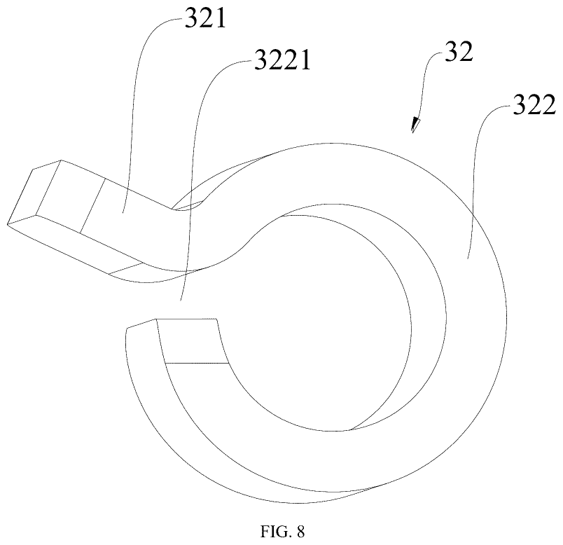

In this embodiment, as shown in FIGS. 3 and 7, the pivot mechanism 30 comprises a rotating shaft 31 and a roll part 32. The rotating shaft 31 passes through the first bracket 12 and its two ends are rotatably connected to the second bracket 22. The roll part 32 is fixed inside the first bracket 12 and wound around the rotating shaft 31. The inner surface of the roll part 32 contacts the outer surface of the rotating shaft 31, and the friction force between the roll part 32 and the rotating shaft 31 generates rotational damping. After installation, the rotating shaft 31 is placed inside the second housing 21. The second housing 21 can cover the rotating shaft, providing a shielding and improving the appearance of the earphone. In addition, the second housing 21 can abut against the rotating shaft 31 to prevent the rotating shaft 31 from sliding along its axial direction.

The roll part 32 is fixed in the first bracket 12, and the rotating shaft 31 can rotate in the roll part 32. The second bracket 22 is fixed together with the rotating shaft 31 and can rotate together with the rotating shaft 31. The roll part 32 can hold the rotating shaft 31 tightly. The friction between the roll part 32 and the rotating shaft 31 achieves damping of the rotating shaft 31, thereby is able to hold the rotation angle between the second housing 21 and the first housing 11, so that the second housing 21 is maintained at the angle of engaging with the ear. After wearing, the rotating shaft 31 will not continuously apply pressure to the pinna, thus solving the problem of earphone wearing comfort.

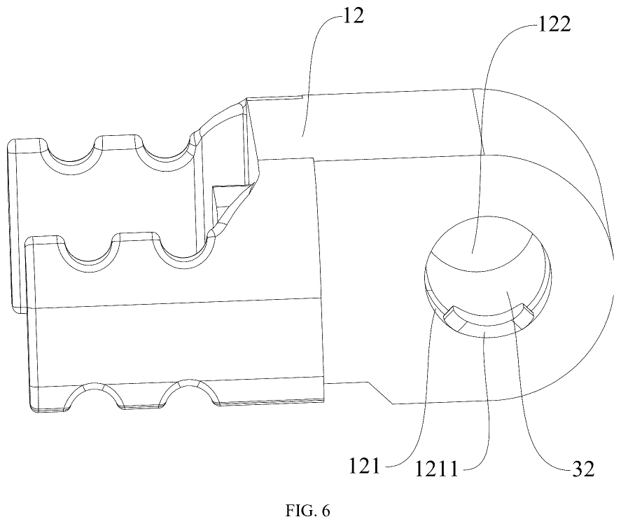

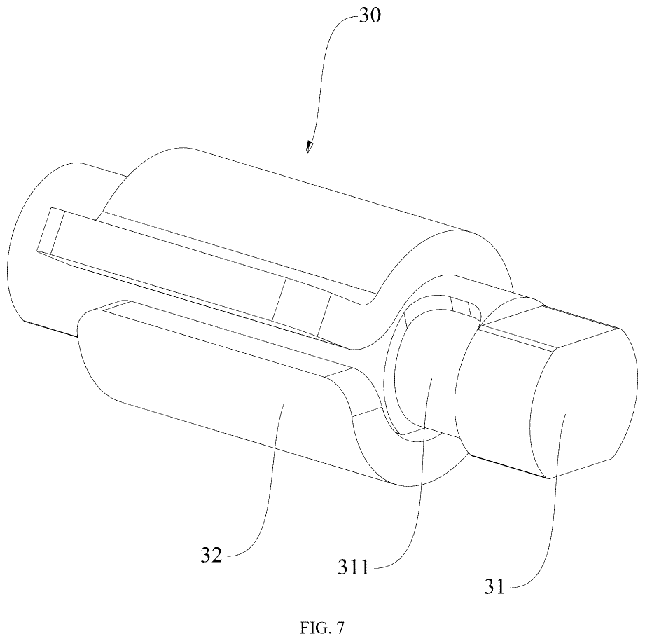

Further, as shown in FIG. 6, the first bracket 12 is provided with a stepped hole, which comprises a first through hole 121 and a second through hole 122. The diameter of the first through hole 121 is smaller than the diameter of the second through hole 122. The roll part 32 is disposed in the second through hole 122, and the rotating shaft 31 passes through the center of the first through hole 121 and the roll part 32. The roll part 32 is installed in the second through hole 122, and the inner diameter of the roll part 32 is equal to or slightly smaller than the diameter of the first through hole 121, so that the outer surface of the rotating shaft 31 abuts against the inner surface of the roll part 32 and generates rotational damping. The rotation angle of the second bracket 22 is held by the damping force, thereby holding the rotation angle of the clamping part 20.

As shown in FIG. 6, the inner surface of the first through hole 121 has a protrusion 1211. As shown in FIG. 7, the outer surface of the rotating shaft 31 has a recessed portion 311. The recessed portion 311 engages with the protrusion 1211 to limit the rotation angle of the rotating shaft 31 relative to the first bracket 12. The engagement between the recessed portion 311 and the protrusion 1211 can limit the extreme rotation positions of the first bracket 12 and the clamping part 20. One extreme position of the clamping part 20 is the aligned position (horizontal state), whereby the earphone is in a non-wearing state. The other extreme position can ensure that the earphone is clamped tightly to the ears of most people to prevent the earphone from falling off.

As a variation, besides configuring a limit on the rotating shaft 31, a limit structure can also be configured at a position far from the rotating shaft 31. The limit structure can be set between the first housing 11 and the second housing 21. The first housing 11 has a first limiting part, and the second housing 21 has a second limiting part. The first limiting part and the second limiting part cooperate to limit the rotation angle between the second housing 21 and the first housing 11. The first bracket 12 is overmolded onto the first housing 11, and the second bracket 22 is overmolded onto the second housing 21. By configuring limiting structures between the first housing 11 and the second housing 21, the overmolded first bracket 12 and the first housing 11 can be regarded as a single part, and the overmolded second bracket 22 and the second housing 21 can also be regarded as a single part. The dimensional chain is short, and the limiting position is far from the axis, so the limiting accuracy is higher and the angle tolerance is smaller. In this embodiment, either of the above two limiting methods can be selected, or both limiting methods can be used in combination.

Preferably, as shown in FIG. 8, the roll part 32 comprises a fixing portion 321 and a roll portion 322. The first end of the roll portion 322 is connected to the fixing portion 321, and the second end of the roll portion 322 is spaced from the first end of the roll portion 322 to form an opening 3221. The fixing portion 321 is fixed inside the first bracket 12, and the roll portion 322 is wound on the rotating shaft 31. When changing from a non-wearing state to a wearing state, the angle between the clamping part 20 and the functional part 10 becomes smaller, and the span of the opening 3221 becomes larger, and the friction between the roll part 32 and the rotating shaft 31 becomes smaller. When changing from a wearing state to a non-wearing state, the angle between the clamping part 20 and the functional part 10 becomes larger, the span of the opening 3221 becomes smaller, and the friction between the roll part 32 and the rotating shaft 31 becomes larger.

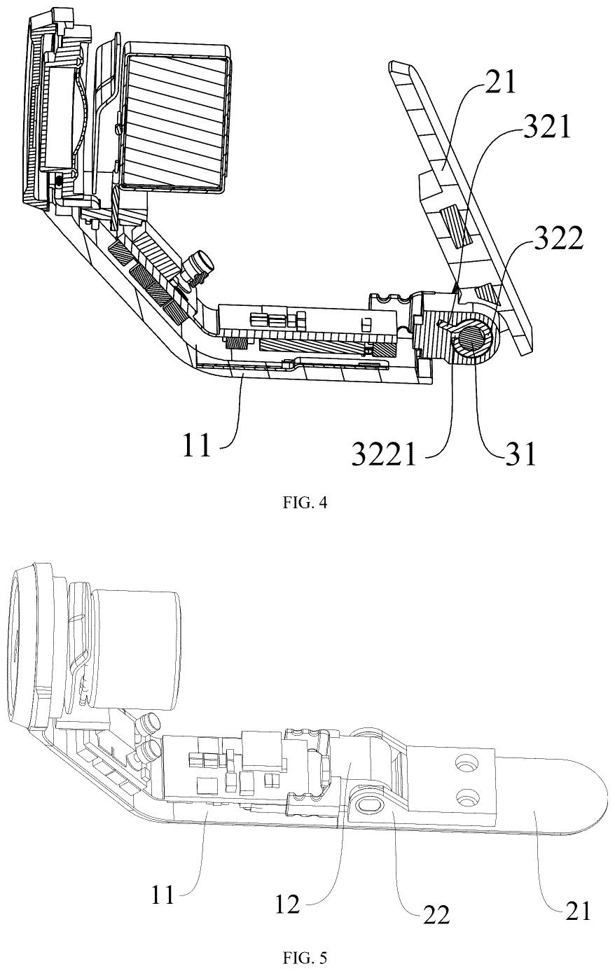

As shown in FIG. 4, during the wearing process, i.e., when changing from the non-wearing state to the wearing state, the rotating shaft 31 drives the clamping part 20 to rotate counterclockwise. The roll portion 322 of the roll part 32 tends to open under the frictional force of the rotating shaft 31, increasing the span of the opening 3221 on the roll portion 322. This reduces the frictional force between the roll part 32 and the rotating shaft 31, resulting in a smaller rotational torque of the rotating shaft 32 and reduced rotational damping of the clamping part 20, facilitating its rotation to the wearing state. During the removal of the earphones, i.e., when changing from the wearing state to the non-wearing state, the rotating shaft 31 drives the clamping part 20 to rotate clockwise. The span of the opening 3221 on the roll portion 322 decreases, increasing the frictional force between the rotating shaft 31 and the roll portion 322 of the roll part 32, resulting in greater rotational damping of the clamping part 20.

The pivot mechanism in this embodiment can achieve the following effects: low damping during wearing, making it relatively convenient to wear; and stable wearing and less likely to fall off due to the relatively high damping when removing the earphones after wearing them.

To achieve the above-mentioned effect of the rotating shaft, the opening 3221 of the roll portion 322 can be configured in the following two ways.

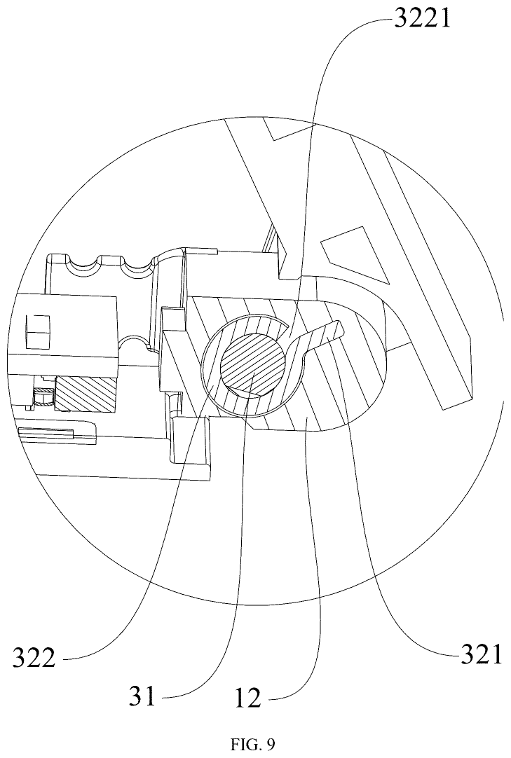

The first way, as shown in FIG. 4, has a fixing portion 321 disposed inside the first bracket 12 facing the first housing 11, and an opening 3221 disposed below the fixing portion 321. The second way, as shown in FIG. 9, has a fixing portion 321 disposed inside the first bracket 12 facing the second housing 21, and an opening 3221 disposed above the fixing portion 321.

As shown in FIG. 4, in the first configuration, when the rotating shaft 31 rotates counterclockwise, the opening 3221 of the roll portion 322 increases in span under the frictional force of the rotating shaft 31 and the friction decreases. Conversely, when the earphone is to be removed, the rotating shaft 31 rotates clockwise, the opening 3221 decreases in span, and the friction increases.

As shown in FIG. 9, in the second configuration, when the rotating shaft 31 rotates counterclockwise, the opening 3221 of the roll portion 322 increases in span under the frictional force of the rotating shaft 31 and the friction decreases. Conversely, when the earphone is being removed, the rotating shaft 31 rotates clockwise, the opening 3221 decreases in size, and the friction increases.

### Example 2

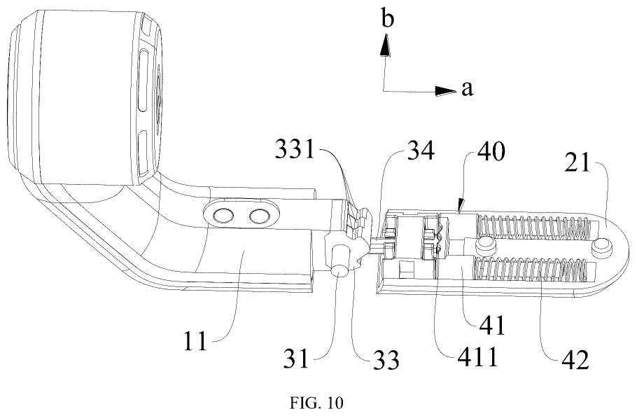

A clip-on earphone, as shown in FIGS. 10 to 12, comprises a functional part 10, a clamping part 20, and a pivot mechanism 30. The functional part 10 comprises a first housing 11. The clamping part 20 comprises a second housing 21. The first housing 11 and the second housing 21 are rotatably connected by the pivot mechanism 30, which is used to adjust and hold the angle between the functional part 10 and the clamping part 20 to form a clamping space for engaging with an ear. The difference between this embodiment and Embodiment 1 lies in the structure of the pivot mechanism 30, while other structures are the same as in Embodiment 1. And the similarities between this embodiment and Embodiment 1 will not be described again.

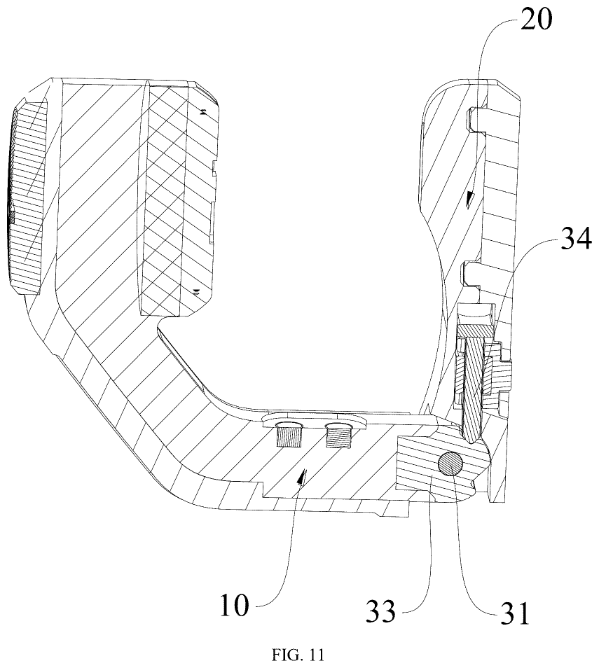

In this embodiment, as shown in FIGS. 10 and 11, the pivot mechanism 30 comprises a rotating shaft 31, a cam 33, and a positioning pin 34. The second housing 21 is rotatably connected to the first housing 11 via the rotating shaft 31. The cam 33 is sleeved on the rotating shaft 31 and fixedly connected to the first housing 11. The cam 33 has multiple positioning teeth 331. The positioning pin 34 is fixedly disposed inside the second housing 21. When the positioning pin 34 engages with any positioning tooth 331, the rotation angle between the second housing 21 and the first housing 11 is adjusted. The cam 33 has multiple positioning teeth 331. When the positioning pin 34 engages with different positioning teeth 331, the rotation angle of the second housing 21 can be adjusted to accommodate different wearers.

Preferably, as shown in FIG. 10, it further comprises an elastic mechanism 40, which is movably mounted on the second housing 21. One end of the elastic mechanism 40 abuts against the second housing 21, and the other end abuts against the positioning pin 34, allowing the positioning pin 34 to move along the length direction of the second housing 21, which is the direction indicated by arrow a in FIG. 10. The positioning pin 34 is connected to the second housing 21 via the elastic mechanism 40. In a wearing state, under the action of the elastic mechanism 40, the positioning pin 34 is engaged with a positioning tooth 331 to hold the rotation angle of the second housing 21, keeping the clamping part 20 in a clamping state and holding the user's pinna. When an external force is applied to the positioning pin 34, the positioning pin 34 overcomes the elastic force of the elastic mechanism 40, the positioning pin 34 is able to disengage from the engagement state with the positioning tooth 331. The clamping part 20 can then change from the wearing state to a non-wearing state, realizing storage and wearing of the earphone.

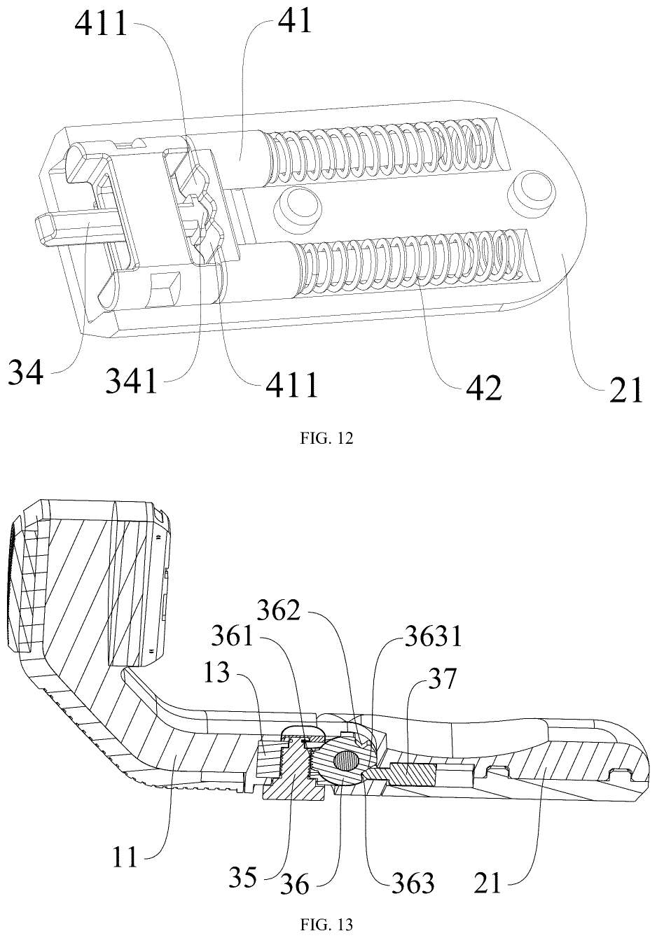

As shown in FIGS. 10 and 12, the elastic mechanism 40 comprises a spring seat 41 and a spring 42. The spring seat 41 is movably mounted on the second housing 21, and the spring 42 is sleeved on the spring seat 41 with one end abutting against the second housing 21. The positioning pin 34 abuts against the spring seat 41. A mounting groove can be provided inside the second housing 21, and the spring seat 41 is movably mounted in the mounting groove. The spring seat 41 can limit the movement of the spring 42 when it extends or retracts.

In one embodiment, as shown in FIG. 10, a plurality of positioning teeth 331 are arranged sequentially along the thickness direction of cam 33, and the height of the plurality of positioning teeth 331 decreases sequentially along the thickness direction of cam 33. The positioning pin 34 is movable along the width direction of second housing 21. The positioning pin 34 is moved along the width direction of second housing 21 so that the positioning pin 34 engages with different positioning teeth 331 to adjust the angle between second housing 21 and first housing 11.

The thickness direction of cam 33 is as shown by arrow b in FIG. 10, and the thickness direction of cam 33 is the same as the width direction of the second housing 21. As shown in FIG. 10, three positioning teeth 331 are provided along the thickness direction of cam 33, and the height of positioning teeth 331 decreases sequentially. Positioning pin 34 is movable along the width direction of the second housing 21. When positioning pin 34 moves to the place corresponding to the first positioning tooth, the clamping part 20 is rotated counterclockwise to engage positioning pin 34 with the first positioning tooth. When the clamping space needs to be increased, positioning pin 34 can be moved along the width direction of the second housing 21, to engage with the second positioning tooth. When the clamping space needs to be further increased, positioning pin 34 can be moved to engage with the third positioning tooth. In this embodiment, multiple gear positions are configured on the cam 33. By moving the positioning pin 34 with a toggle switch, the positioning pin 34 can be engaged with the positioning teeth 331 of different gear positions, thereby adapting to different wearers.

Further, as shown in FIG. 12, the side of the spring seat 41 that abuts against the positioning pin 34 is provided with multiple recessed grooves 411 along the width direction of the second housing 21. The end of the positioning pin 34 is provided with a mating portion 341 that cooperates with the recessed grooves 411. When the positioning pin 34 moves along the width direction of the second housing 21, the mating portion 341 can be located in different recessed grooves 411. The positioning pin 34 is limited by the cooperation between the recessed grooves 411 and the mating portion 341. The number of recessed grooves 411 is the same as the number of positioning teeth 331, and multiple recessed grooves 411 are arranged in a one-to-one correspondence with the positioning teeth 331. When the positioning pin 34 is located in one of the recessed grooves 411, it can correspond exactly to one of the positioning teeth 331, so that when the clamping part 20 is rotated, the positioning pin 34 can engage with the corresponding positioning tooth 331.

As a variation, multiple positioning teeth 331 can also be arranged sequentially along the circumference of the cam 33. For example, three positioning teeth 331 are arranged sequentially in a clockwise direction on the outer circumference of the cam 33, namely the first positioning tooth, the second positioning tooth, and the third positioning tooth. When the rotating shaft 31 drives the positioning pin 34 to rotate counterclockwise, the positioning pin 34 first engages with the third positioning tooth. At this point, the angle between the functional part 10 and the clamping part 20 is the largest, and the clamping space of the earphone is also the largest. When the positioning pin 34 continues to rotate counterclockwise until it engages with the second positioning tooth, the angle between the functional part 10 and the clamping part 20 becomes smaller, and the clamping space of the earphone also becomes smaller. When the positioning pin 34 continues to rotate counterclockwise until it engages with the first positioning tooth, the angle between the functional part 10 and the clamping part 20 continues to become smaller, and the clamping space of the earphone is the smallest. The number of positioning teeth 331 described above is merely an example. In practical applications, the number of positioning teeth 331 can be set according to requirements. This embodiment does not specifically limit the number of positioning teeth 331. In this embodiment, by setting multiple positioning teeth 331 in the circumferential direction of the cam 33, the earphone clamping space can also be adjusted to make the earphones suitable for different wearers.

### Example 3

A clip-on earphone, as shown in FIGS. 13 to 16, comprises a functional part 10, a clamping part 20, and a pivot mechanism 30. The functional part 10 comprises a first housing 11. The clamping part 20 comprises a second housing 21. The first housing 11 and the second housing 21 are rotatably connected by the pivot mechanism 30, which is used to adjust and hold the angle between the functional part 10 and the clamping part 20 to form a clamping space for engaging with the ear. The difference between this embodiment and Embodiment 1 lies in the structure of the pivot mechanism 30; while other structures are the same as in Embodiment 1, and the similarities between this embodiment and Embodiment 1 will not be described again.

In this embodiment, the pivot mechanism 30 comprises a rotating shaft 31, a worm 35, a worm wheel 36, and a cam rod 37. The second housing 21 is rotatably connected to the first housing 11 via the rotating shaft 31. The worm 35 is rotatably disposed in the first housing 11. The worm wheel 36 is sleeved on the rotating shaft 31 and is rotatable relative to the rotating shaft 31. The worm wheel 36 has teeth portion 361 and groove 362 at its circumference. The teeth portion 361 meshes with the worm 35. The cam rod 37 is fixedly disposed at the second housing 21 and is able to engage with the groove 362.

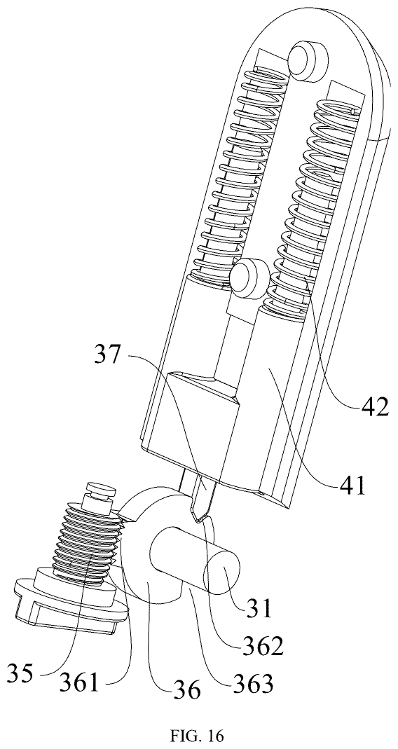

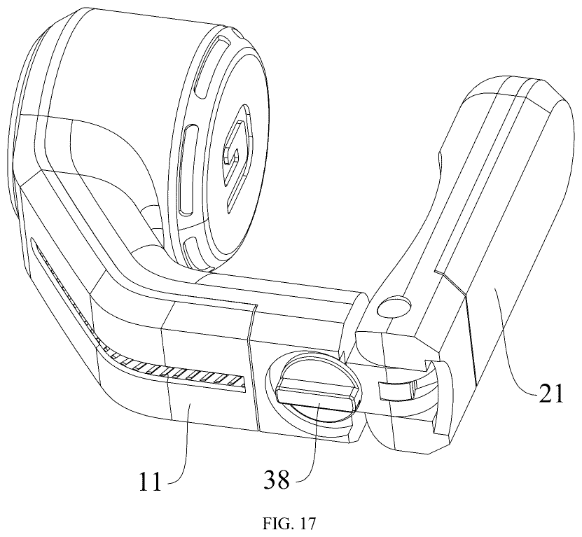

As shown in FIG. 13, the functional part 10 also comprises a third bracket 13, which is fixedly connected to the first housing 11. The worm 35 and the worm wheel 36 are both arranged in the third bracket 13. As shown in FIGS. 15 and 16, when wearing the earphone, rotating the clamping part 20 causes the cam rod 37 at the clamping part 20 to engage with the groove 362 of the worm wheel 36. Then, rotating the worm 35 causes the worm wheel 36 to rotate around the rotating shaft 31, thereby changing the position of the groove 362 on the worm wheel 36. This allows for adjustment of the rotation angle of the clamping part 20, achieving stepless adjustment to accommodate different users. As shown in FIG. 17, one end of the worm 35 extends out of the first housing 11 and is provided with a hand-operated member 38 for rotating the worm 35. Rotating the hand-operated member 38 drives the worm 35 to rotate.

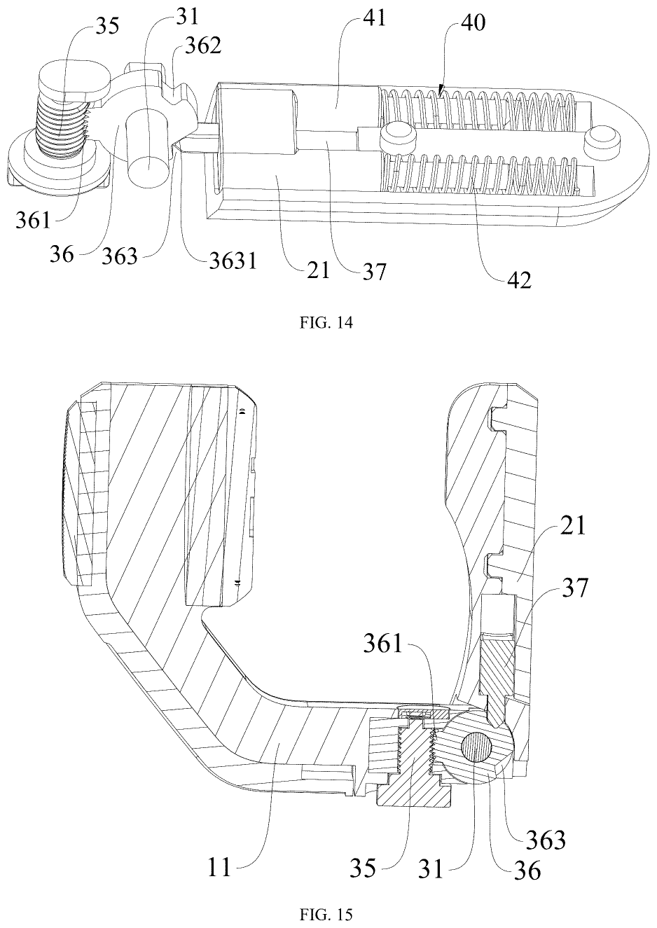

Further, as shown in FIG. 14, it also comprises an elastic mechanism 40, which is movably mounted at the second housing 21. One end of the elastic mechanism 40 abuts against the second housing 21, and the other end is connected to the cam rod 37, allowing the cam rod 37 to move along the length of the second housing 21. The elastic mechanism 40 comprises a spring seat 41 and a spring 42. The spring seat 41 is movably mounted inside the second housing 21, and the spring 42 is sleeved on the spring seat 41 with one end abutting against the second housing 21. The cam rod 37 is fixedly connected to the spring seat 41. The elastic force of the elastic mechanism 40 allows the cam rod 37 to engage with the groove 362 of the worm 36. When the clamping part 20 needs to be reset to the non-wearing state, external force can overcome the elastic force of the elastic mechanism 40, causing the cam rod 37 to exit the groove 362 of the worm wheel 36, thus resetting the clamping part 20 to the aligned state.

As shown in FIGS. 13 and 14, a limiting groove 363 is also provided on the outer circumference of the worm wheel 36. The teeth portion 361, the groove 362 and the limiting groove 363 are arranged sequentially in a clockwise direction on the outer circumference of the worm wheel 36. In the wearing state, the cam rod 37 is located in the groove 362. As shown in FIG. 13, in the non-wearing state, the cam rod 37 is located in the limiting groove 363. And the first side surface 3631 of the limiting groove 363 near the groove 362 is inclined relative to the horizontal plane and exerts a pre-pressure on the cam rod 37, so that when the worm 35 rotates, the second housing 21 is always in a horizontal state.

In the non-wearing state, the cam rod 37 is in a horizontal position and engages with the limiting groove 363 on the worm wheel 36. The limiting groove 363 exerts a pre-pressure on the cam rod 37. Regardless of how the worm 35 adjusts the rotation of the worm wheel 36, the cam rod 37 remains within the limiting groove 363, keeping the clamping part 20 in a horizontal position and the entire earphone in a non-wearing state. When the earphone needs to be worn, the clamping part 20 is rotated counterclockwise, causing the cam rod 37 to disengage from the limiting groove 363 and engage with the groove 362. When the clamping part 20 and the rotating shaft 31 rotate together, the worm wheel 36 does not rotate. It only rotates when the worm 35 rotates. After the cam rod 37 engages with the groove 362, rotating the worm 35 rotates the worm wheel 36. When the worm wheel 36 rotates, it moves the cam rod 37 engaged with the groove 362, thereby rotating the clamping part 20 to adjust its position to accommodate different users.

In this embodiment, the rotational angle of the worm wheel 36 corresponds to the movement stroke of the cam rod 37 on the first side surface 3631 of the limiting groove 363. That is, when the teeth portion on the worm wheel 36 move to the top of the worm 35, the cam rod 37 is located at the top of the first side surface 3631. When the teeth portion on the worm wheel 36 move to the bottom of the worm 35, the cam rod 37 is located at the bottom of the first side surface 3631. This ensures that no matter how the worm wheel 36 is rotated, the first side surface 3631 of the limiting groove 363 always exerts a pre-pressure on the cam rod 37, which can keep the clamping part 20 in a horizontal state, and thus keep the clamping part 20 in a non-wearing state.

The above description is only preferred embodiments of the present application. It should be noted that for those skilled in the art, several improvements and modifications can be made without departing from the principle of the present application, and these improvements and modifications should also be considered within the protection scope of the present application.

1. A clip-on earphone, characterized by comprising:
a functional part, comprising a first housing;
a clamping part, comprising a second housing;
a pivot mechanism;
wherein the first housing and the second housing are rotatably connected via the pivot mechanism, for adjusting and holding an angle between the functional part and the clamping part to form a clamping space for engaging with an ear.

2. The clip-on earphone according to claim 1, characterized in that,
the functional part further comprises a first bracket fixedly disposed in the first housing; and
the clamping part further comprises a second bracket fixedly disposed in the second housing; and
the second bracket is rotatably connected to the first bracket via the pivot mechanism.

3. The clip-on earphone according to claim 2, characterized in that,
the pivot mechanism comprises a rotating shaft and a roll part;
wherein the rotating shaft passes through the first bracket and its two ends are rotatably connected to the second bracket, and the roll part is fixed in the first bracket and wound around the rotating shaft, and an inner surface of the roll part contacts an outer surface of the rotating shaft, and a friction force between the roll part and the rotating shaft generates rotational damping.

4. The clip-on earphone according to claim 3, characterized in that,
the first bracket has a stepped hole, comprising a first through hole and a second through hole;
wherein a diameter of the first through hole is smaller than a diameter of the second through hole, and the roll part is disposed in the second through hole, and the rotating shaft passes through a center of the first through hole and the roll part.

5. The clip-on earphone according to claim 4, characterized in that,
an inner surface of the first through hole is provided with a protrusion, and the outer surface of the rotating shaft is provided with a recessed portion;
wherein the recessed portion engages with the protrusion to limit a rotation angle of the rotating shaft relative to the first bracket.

6. The clip-on earphone according to claim 2, characterized in that,
the first housing is provided with a first limiting part, and the second housing is provided with a second limiting part;
wherein the first limiting part and the second limiting part cooperate to limit a rotation angle of the second housing relative to the first housing.

7. The clip-on earphone according to claim 3, characterized in that,
the roll part comprises a fixing portion and a roll portion;
wherein a first end of the roll portion is connected to the fixing portion, and a second end of the roll portion is spaced apart from the first end of the roll portion to form an opening, and the fixing portion is fixed in the first bracket, and the roll portion is wound on the rotating shaft; and
when changing from a non-wearing state to a wearing state, an angle between the clamping part and the functional part decreases, and a span of the opening increases, and the friction force between the roll part and the rotating shaft decreases; and
when changing from the wearing state to the non-wearing state, the angle between the clamping part and the functional part increases, and the span of the opening decreases, and the friction force between the roll part and the rotating shaft increases.

8. The clip-on earphone according to claim 7, characterized in that,
the fixing portion is disposed in the first bracket and facing the first housing, and the opening is disposed below the fixing portion; or
the fixing portion is disposed in the first bracket and facing the second housing, and the opening is disposed above the fixing portion.

9. The clip-on earphone according to claim 1, characterized in that,
the pivot mechanism comprises a rotating shaft, a cam, and a positioning pin;
wherein the second housing is rotatably connected to the first housing via the rotating shaft, and the cam is sleeved on the rotating shaft and fixedly connected to the first housing, and the cam is provided with multiple positioning teeth, wherein the positioning pin is movably disposed in the second housing; and when the positioning pin engages with any of the positioning teeth, a rotation angle between the second housing and the first housing is adjusted.

10. The clip-on earphone according to claim 9, characterized by
further comprising an elastic mechanism, movably mounted at the second housing;
wherein one end of the elastic mechanism abuts against the second housing, and one other end abuts against the positioning pin, so that the positioning pin is able to move along a length direction of the second housing.

11. The clip-on earphone according to claim 10, characterized in that,
the elastic mechanism comprises a spring seat and a spring;
wherein the spring seat is movably disposed in the second housing, and the spring is sleeved on the spring seat with one end abutting against the second housing, and the positioning pin abuts against the spring seat.

12. The clip-on earphone according to claim 11, characterized in that,
multiple positioning teeth are arranged sequentially along a thickness direction of the cam;
wherein heights of the multiple position teeth decrease sequentially along the thickness direction of the cam, and the positioning pin is movable along a width direction of the second housing, wherein moving the positioning pin along the width direction of the second housing allows the positioning pin to engage with different one of the positioning teeth to adjust the rotation angle between the second housing and the first housing.

13. The clip-on earphone according to claim 12, characterized in that,
a side of the spring seat that abuts against the positioning pin is provided with a plurality of recessed grooves along the width direction of the second housing, and an end of positioning pin is provided with a mating portion adapted to engage with the recessed grooves; and
when the positioning pin moves along the width direction of the second housing, the mating portion is able to be in different recessed grooves, and the positioning pin is positioned by an engagement between the recessed grooves and the mating portion.

14. The clip-on earphone according to claim 10, characterized in that,
the multiple positioning teeth are arranged sequentially along a circumferential direction of the cam.

15. The clip-on earphone according to claim 1, characterized in that,
the pivot mechanism comprises a rotating shaft, a worm, a worm wheel, and a cam rod;
wherein the second housing is rotatably connected to the first housing via the rotating shaft, and the worm is rotatably disposed in the first housing, and the worm wheel is sleeved on the rotating shaft and is rotatable relative to the rotating shaft, and the worm wheel has a teeth portion and a groove on its outer circumference, and the teeth portion meshes with the worm, and the cam rod is movably disposed at the second housing and is adapted to engage with the groove.

16. The clip-on earphone according to claim 15, characterized by
further comprising an elastic mechanism, movably mounted at the second housing;
wherein one end of the elastic mechanism abuts against the second housing, and one other end is connected to the cam rod, so that the cam rod is able to move along a length direction of the second housing.

17. The clip-on earphone according to claim 16, characterized in that,
the elastic mechanism comprises a spring seat and a spring;
wherein the spring seat is movably disposed in the second housing, and the spring is sleeved on the spring seat with one end abutting against the second housing, and the cam rod is fixedly connected to the spring seat.

18. The clip-on earphone according to claim 16, characterized in that,
the outer circumference of the worm wheel is further provided with a limiting groove;
wherein the teeth portion, the groove, and the limiting groove are arranged sequentially at intervals in a clockwise direction at the outer circumference of the worm wheel; and
in a wearing state, the cam rod is located in the groove; and
in a non-wearing state, the cam rod is located in the limiting groove, and a first side surface of the limiting groove is inclined relative to a horizontal plane and exerts a pre-pressure on the cam rod, so that when the worm rotates, the second housing is always in an aligned state.

19. The clip-on earphone according to claim 18, characterized in that,
when the teeth portion of the worm wheel moves to a top of the worm, the cam rod is located at a top of the first side surface; and when the teeth portion of the worm wheel move to a bottom of the worm, the cam rod is located at a bottom of the first side surface.
